(19) United States
(12) Patent Application Publication
(10) Pub. No.: US 2009/0238545 A1
(43) Pub. Date: Sep. 24, 2009

(54) REPRODUCING DEVICE AND PROGRAM

(75) Inventors: Germano Leichsenring, Osaka (JP); Tomokazu Kanamaru, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/092,998

(22) PCT Filed: Nov. 20, 2006
(86) PCT No.: PCT/JP2006/323102

§ 371 Date: May 8, 2008

(30) Foreign Application Priority Data
Nov. 22, 2005 (JP) 2005-337388

(51) Int. Cl. H04N 5/00

(52) U.S. Cl. 386/125

(57) ABSTRACT

A reproducing device includes: a user setting storage unit storing user setting preference information set by a user; a reproduction control storage unit storing reproduction-control-use preference information for controlling reproduction of a video content; a BD-J module executing an application together with reproduction of the video content recorded on a recording medium, such as a BD-ROM; a detection module (i) detecting whether the BD-ROM is mounted and, (ii) when the BD-ROM is mounted after once being removed, determining whether to continue, together with reproduction of the mounted BD-ROM, the execution of the application which was executed before the removal; and a password preference information setting module causing a reproduction control storage unit to store the user setting preference information as the reproduction-control-use preference information, when an application termination instruction is received from the user, or when continuation of the execution is determined.

### TECHNICAL FIELD

The present invention relates to a reproducing device that reproduces a video content recorded on a recording medium, such as BD-ROM (Blu-Ray Disk Read Only Memory), and particularly to a technique of reproducing the recording medium that stores an application program (herein after, referred to as “application”) that is executed when the video content is reproduced.

### BACKGROUND ART

Conventionally, a reproducing device that reproduces a video content, such as a movie, recorded on a recording medium, such as BD-ROM, is well-known.

When the reproducing device reproduces a recording medium storing an application that is executed when a video content is reproduced, a combination of the reproduction of the video content and the execution of the application provides users with a wide variety of services. As an example of such services, the application draws graphics in synchronization with an image and sound of a video content. Thus, users are provided with attentive services.

Also, the reproducing device allows settings of preference information, such as a menu language of the reproducing device, parental lock information that indicates an age limit for users to view a video content, country information, default audio language information, and default subtitle language information. The reproducing device reproduces a video content according to the setting of preference information.

Note that Patent Document 1 below discloses a reproduction control method used for recording a medium that includes parental lock information as well as a video content. The video content includes the parental lock information that indicates an age limit for users to view the video content. According to this reproduction control method, when an age indicated by the parental lock information of the reproducing device falls within an age limit range of the video content, the reproducing device is controlled not to reproduce the video content.

Patent Document 1: Japan Patent Publication No. 2000-287155

### DISCLOSURE OF THE INVENTION

### Problems the Invention is Attempting to Solve

According to a conventional reproducing device, when the application involves update processing of the preference information, the preference information set in the reproducing device is updated through the execution of the application. Once the preference information is updated, even after a termination of the application, the conventional reproducing device performs all subsequent reproduction of the video content based on the updated preference information.

Accordingly, the following problem occurs. For example, when the preference information updated by the execution of the application is the parental lock information, since the parental lock information of the reproducing device is changed, reproduction control that is not intended by users may be performed, such as reproduction of a video content that is not authorized by the parental lock information that the user originally set.

The present invention is made in view of the above problem, and therefore it is an object of the present invention to provide a reproducing device as follows. When an application and a video content are recorded on a recording medium, such as BD-ROM, after the preference information is updated by the execution of the application, in a subsequent application execution step, the reproducing device performs control so as to prevent the video content from being unintentionally reproduced.

### Means for Solving the Problems

A reproducing device in accordance with the present invention reads a video content and an application from a recording medium and reproduces the video content. The application is executed when the video content is reproduced. The reproducing device includes a first storage unit that stores first setting information set by a user for controlling reproduction of the video content, a second storage unit that stores second setting information being readable and writable by the application and being used for controlling reproduction of the video content, an execution unit operable to execute the application based on the second setting information when the video content is reproduced, and a control unit operable, at a time when the execution of the application is terminated, to control the second storage unit to replace the second setting information with the first setting information.

### EFFECTS OF THE INVENTION

With the above configuration, it is the second setting information that is updated by the execution of the application caused by the reproducing device of the present invention. When the execution of the application is terminated, the second setting information is replaced by the first setting information set by a user. That is to say, the second setting information that is updated by the execution of the application is valid exclusively when the application is being executed.

Accordingly, for example, when the reproducing device reproduces a video content or the like recorded on another recording medium that is irrelevant to the terminated application, the reproduction is controlled based on the first setting information that is set by the user. Hence, the reproducing device is able to perform control to prevent the reproduction that is not intended by the user, such as reproduction based on different information from the parental lock information preset by the user.

The reproducing device further includes a reception unit operable to receive, from the user, a termination instruction to terminate the execution of the application. The control unit may determine a time when the reception unit receives the termination instruction as the time when the execution of the application is terminated.

Determining “the execution of the application is terminated” means that the time when the reception unit receives the termination instruction is regarded as the time when the execution of the application is terminated.

With this configuration, since the termination instruction to terminate the application in execution can be received from the user, upon receiving the termination instruction from the user, the second setting information is replaced with the first setting information. Hence, in a case, for example, where the same video content is reproduced again after the termination of the application, or where a new video content that is irrelevant to the application is reproduced, reproduction control is performed with use of the second setting information that has the same content as the first setting information originally set by the user. Thus, the reproducing device can perform reproduction control that reflects the user's intention.

The recording medium includes link information indicating whether or not the application is executed for both the video content included in the recording medium and a video content included in another recording medium. The reproducing device further includes an interface from which the recording medium is removable, and a detection unit operable to detect (i) whether the recording medium has been removed from the interface, and (ii) whether the other recording medium includes the link information when the other recording medium is mounted on the interface after the removal of the recording medium. The control unit may determine a time when the detection unit detects that the other recording medium does not include the link information as the time when the execution of the application is terminated.

With this configuration, when the recording medium that stores the application is removed during the execution of the application and the other recording medium is mounted instead, the link information enables the reproducing device to determine whether to continue the execution of the application along with the reproduction of the video content recorded on the other recording medium.

Suppose that a series of video contents are recorded on a plurality of recording media and that an application that is common to these contents is recorded on one recording medium, when a user mounts a recording medium that stores another series of video contents during the execution of the application, the execution of the application is assumed to be terminated. Then, the second setting information is replaced by the first setting information. Accordingly, when the recording medium that stores another series is started, the reproduction is performed, not with the second setting information that can be updated by the application, but with the first setting information that has been preset by the user. Thus, the reproduction control that is not intended by the user is prevented.

The first storage unit stores a password associated with the first setting information. The control unit further includes a determination subunit operable to determine, when the application in execution attempts to update the second setting information, whether the password is set associated with the first setting information that corresponds to the second setting information. When the determination subunit determines that the password is set, the control unit does not allow the second setting information to be updated. When the determination subunit determines that the password is not set, the control unit allows the second setting information to be updated.

With this configuration, when the second setting information is not intended to be updated by the application in execution either, if the user stores the password associated with the first setting information, the second setting information is prevented from being updated by the application in execution.

The reproducing device further includes a notification unit operable to notify, according to a determination result by the determination subunit, the user of access information indicating whether the application has updated the second setting information.

With this configuration, when the password set for the first setting information is stored, the user can be notified whether the second setting information has been updated by the application in execution.

The reproducing device further includes a display unit. The notification unit may notify the user with use of the display unit that displays an image indicating the access information.

The reproducing device further includes an audio output unit. The notification unit may notify the user with use of the audio output unit that outputs a sound indicating the access information.

With this configuration, the user can be notified, with use of the image and the sound, information that indicates whether the second setting information has been updated by the application in execution while the user is viewing the video content that is reproduced at the same time as the execution of the application.

The reproducing device performs wired or wireless communication with an input unit that is provided with a display unit and that receives an instruction to control reproduction of the video content from the user. The notification unit may notify the user with use of the display unit that displays an image indicating the access information.

The reproducing device performs wired or wireless communication with an input unit that is provided with a display unit and that receives an instruction to control reproduction of the video content from the user. The notification unit may notify the user with use of the audio output unit that outputs a sound indicating the access information.

With this configuration, the user can be notified, with use of a remote input device, such as a remote controller, the information that indicates whether the second setting information has been updated by the application in execution without being prevented from viewing the video content.

The first setting information and the second setting information include parental lock information indicating a restriction placed on the user to view the video content according to an age of the user. The execution of the application updates the second setting information. The password is set associated with the first setting information. On the condition that the update of the second setting information involves tightening of the restriction indicated by the second setting information, the control unit allows the second setting information to be updated.

With this configuration, no particular problems occur for the purposes of the parental lock. The application in execution performs writing in the parental lock information for tightening a restriction on a user to view a video content. For example, suppose a current setting of the reproducing device defines an age limit for viewing the video content is under the age of twenty, when the age limit is updated to under the age of eighteen, the age limit that is defined by the parental lock information originally set by the user is observed. If the execution of the application updates the parental lock information, no particular problems occur for the purposes of the parental lock. In other words, it is prevented to display inappropriate movies for youths.

### BRIEF DESCRIPTION OF THE DRAWINGS

FIG. 1 is a view of a reproducing device in accordance with an embodiment of the present invention and a service condition of the reproducing device;

FIG. 2 is a view showing the structure of BD-ROM in accordance with the embodiment of the present invention;

FIG. 3 is a view showing a layer model of software for the BD-ROM;

FIG. 4A shows an example of an image displayed by reproduction control in HDMV mode;

FIG. 4B shows an example of an image displayed by reproduction control in BD-J mode;

FIG. 5 is a configuration diagram of the reproducing device in accordance with the embodiment of the present invention;

FIG. 6 is a view showing the configuration of BD middleware and a storage unit of the reproducing device;

FIG. 7A shows an example of password setting information that corresponds to preference information;

FIG. 7B shows an example of a user setting preference information table;

FIG. 7C shows an example of a reproduction-control-use preference information table;

FIG. 7D shows an example of setting information after update of the reproduction-control-use preference information;

FIG. 8 shows a display example of a password setting screen;

FIG. 9A shows a display example of the password setting screen for changing user setting preference information;

FIG. 9B shows an example of a display of an entry screen for the user setting preference information;

FIG. 10 is a view showing an example of reproduction units of the BD-ROM;

FIG. 11 is an operational flow diagram of the reproducing device;

FIG. 12 is an operational flow diagram of application execution termination determination processing in accordance with the embodiment of the present invention;

FIG. 13 shows an example of an update notice of the reproduction-control-use preference information;

FIG. 14 shows an example of an update rejection notice of the reproduction-control-use preference information; and

FIG. 15 is a block diagram of a reproducing device in accordance with a modification of the present invention.

### REFERENCE NUMERALS

101 reproducing device
102 remote controller
103 display
104 BD-ROM
105 speaker
106 BD-ROM insertion slot
414 reproduction control unit
420 UO detection module
430 storage unit
431 user setting storage unit
432 reproduction-control-use storage unit
500 BD middleware
510 HDMV module
520 BD-J module
530 mode management module
540 preference setting management module
541 password preference information setting module
542 detection module
543 notification module
550 AV reproduction library
600 Java™ application

### BEST MODE FOR CARRYING OUT THE INVENTION

### Embodiment 1

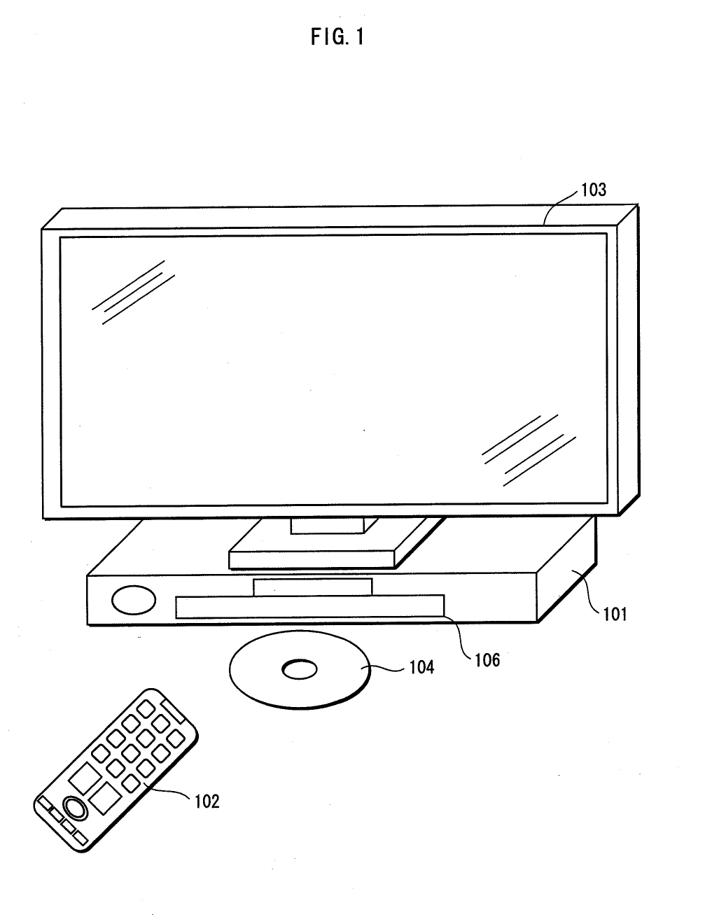

FIG. 1 is a view of a reproducing device in accordance with an embodiment of the present invention and its service condition.

According to FIG. 1, a reproducing device 101 is provided with an insertion slot 106 for BD-ROM 104. A home theater system is composed of a remote controller 102 and a display 103. In response to user operation of the remote controller 102, a video content, such as a movie recorded on the BD-ROM 104, is reproduced, and the reproduced video is displayed on the display 103.

### <Outline>

The reproducing device 101 in accordance with the embodiment of the present invention stores preference information that is preset by a user (herein after, referred to as “user setting preference information”), and has a storage area of preference information that is used for reproducing a video content (herein after, referred to as “reproduction-control-use preference information”). At a point when the reproducing device 101 is turned ON, a content identical to the user setting preference information is set as a content of the reproduction-control-use preference information.

The BD-ROM 104 that stores a video content, such as a movie, and an application to be executed together with reproduction of the video content is inserted into the insertion slot 106. When the reproduction of the BD-ROM 104 is requested by the user, the reproducing device 101 reproduces, based on the reproduction-control-use information, the video content on reproduction control units of the BD-ROM 104 that are described later, and executes the application.

When the application in execution requests an access (reading and writing) to the preference information, the reproducing device 101 controls the application to have access to the reproduction-control-use preference information. When the application is terminated, the user setting preference information is written as the same content of the reproduction-control-use preference information. After the termination of the application, a subsequent video content is reproduced with use of the reproduction-control-use preference information that has the same content as the user setting preference information.

In other words, the reproducing device 101 performs control so that an application executed together with the reproduction of a subsequent video content gains access to the reproduction-control-use preference information that has the same content as the user setting preference information.

Note that this embodiment describes the BD-ROM 104 that stores an AV content, such as a movie, and an application to be executed together with reproduction of the AV content. However, instead of the BD-ROM 104, CD-ROM (Compact Disk Read Only Memory) or DVD-ROM (Digital Versatile Disk Read Only Memory) is applicable. In addition, a Java application is described as the application in accordance with the embodiment of the present invention.

### <Structure of BD-ROM 104>

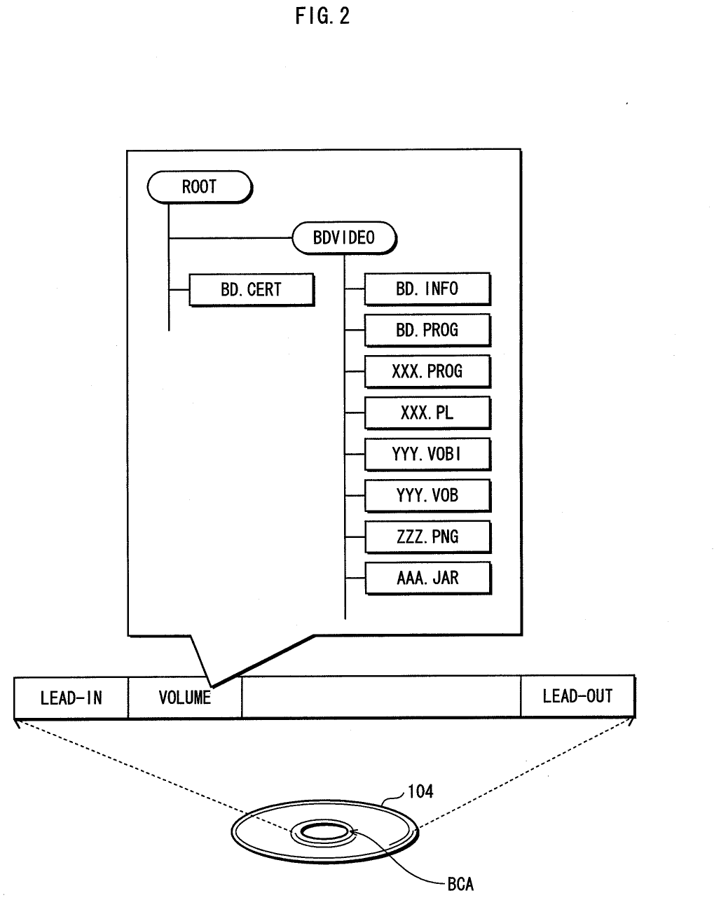

FIG. 2 is a view showing the structure of directories and files of the BD-ROM 104 reproduced by the reproducing device 101.

Similarly to other optical disks, such as a DVD and a CD, the BD-ROM 104 has a storage area that expands in a spiral fashion from its inner circumference to its outer circumference. The storage area has a logic address space for storing logic data between a lead-in of the inner circumference and a lead-out of the outer circumference. Inside the lead-in, there is a special area called a BCA (Burst Cutting Area) that can be read only by a drive. Since this area cannot be read by an application, this area is used, for example, for a copyright protection technique.

The logic address space stores application data, such as video data, with file system information (volume) at the top of the application data. The volume area has a layer model composed of a physical layer, a file system layer, and an application layer. The structure shown in FIG. 2 is formed on the application layer.

The file system used herein is UDF (Universal Disk Format), ISO9660 or the like, and is able to read logic data recorded on the BD-ROM 104 with use of the structure of the directories and the files.

The following describes the structure of the directories and the files on the BD-ROM 104 in accordance with the embodiment of the present invention.

The structure of the directories and the files on the BD-ROM 104 are as follows. A BDVIDEO directory is located immediately below a ROOT directory. These directories store data, such as an AV content and management information.

The following describes files that are recorded in the BDVIDEO directory of FIG. 2 and a BD. CERT file.

BD. INFO (fixed file name) is a file of BD management information concerning the entire BD disk. The BD. INFO is initially read when the reproducing device 101 starts to reproduce the BD.

Note that when an application of the BD-ROM 104 is an application to be executed together with the reproduction of a video content of another BD-ROM (herein after, referred to as “unbound application”), BD. INFO records application information indicating the application is an unbound application.

BD. PROG (fixed file name) is a file of a BD reproduction program that stores the entire BD disk.

XXX. PL (“XXX” is variable, extension “PL” is fixed) is a file of BD management information storing playlist information that stores a scenario. For each file, one playlist is stored.

XXX. PROG (“XXX” is variable, extension “PROG” is fixed) is a file of a BD reproduction program for each aforementioned playlist. A playlist associated with each program is identified by a file body name (matched with “XXX”).

In addition, XXX. PROG stores information concerning a lifecycle of an application. The information of the application lifecycle includes start information showing which application (JAR file that is described later) to be started when reproduction units are switched, and termination information showing when to terminate the started application. The termination information shows when to switch the reproduction units of the video content, when to terminate the reproduction of the video content, when to eject the BD-ROM, and the like.

YYY. VOB (“YYY” is variable, extension “VOB” is fixed) is a file of AV data that composes an AV content. More specifically, the file stores an MPEG stream that is the AV data. For each file, one VOB is stored.

YYY. VOBI (“YYY” is variable, extension “VOBI” is fixed) is a file of BD management information. More specifically, the file records management information concerning the aforementioned AV data of the VOB file. A VOB associated with each program is identified by a file body name (matched with “YYY”).

ZZZ. PNG (“ZZZ” is variable, extension “PNG” is fixed) is a file that stores image data PNG (an image format standardized by W3C) for constituting subtitles and menus, and is stored for each PNG image data.

AAA. JAR (“AAA” is variable, extension “JAR” is fixed) is a file that describes a Java application for performing dynamic scenario control using a Java virtual machine. This file is used when the Java application controls reproduction of each title indicating reproduction units of the AV content on the BD-ROM 104. Note that a detail of each title showing a reproduction unit is described later.

BD. CERT (fixed file name) is a file of a certificate used for verifying a signature of the Java application on the BD-ROM 104.

### <Reproduction Control of BD-ROM 104>

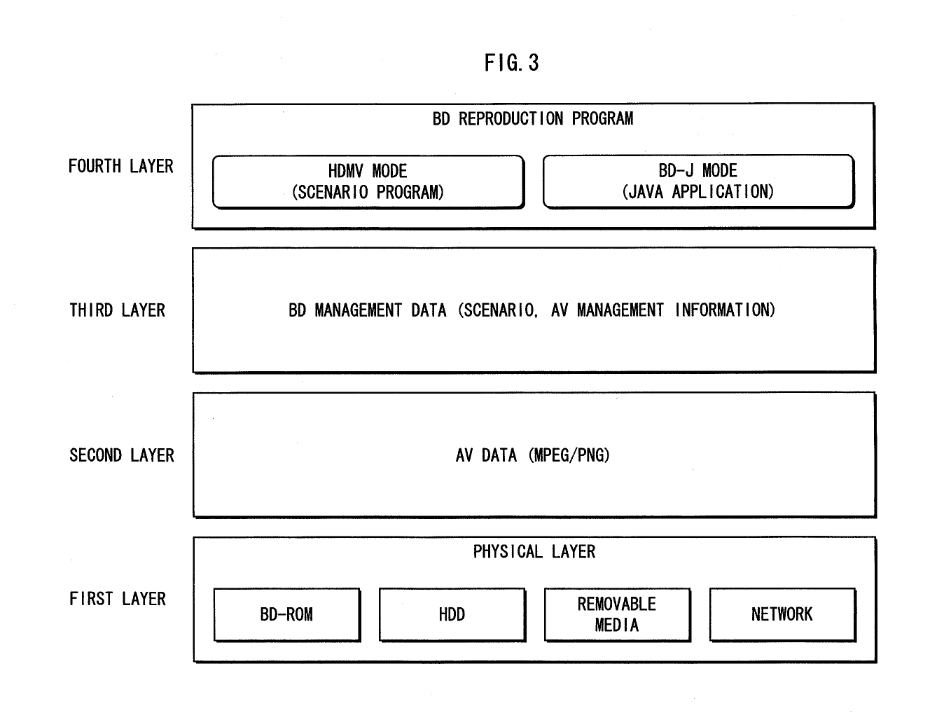

Subsequently, with reference to FIG. 3, a description is made on the layer model of when the reproducing device 101 controls reproduction of the BD-ROM 104.

FIG. 3 shows the layer model that is obtained by functionally categorizing abovementioned files in FIG. 2. Each layer is described as follows.

A first layer shown in FIG. 3 is a physical layer, and supplies an AV stream whose reproduction is to be controlled. As shown in the first layer, the AV stream to be controlled is supplied not only from the BD-ROM 104, but also from any recording media and communication media including HDD that is a recording medium preset in the reproducing device 101, removable media such as SDRAM, and networks.

The first layer controls disk access, card access, network communication and the like whose supply sources are HDD, removable media and networks.

A second layer is a layer of AV data. The second layer defines what decoding method is used to decode the AV stream supplied by the first layer.

A third layer (BD management data) is a layer that defines a static scenario of the AV stream. The static scenario is reproduction path information predefined by a disk producer and stream management information that shows attributes of compression, resolution and the like of a video stream and an audio stream. This third layer (static scenario) defines the reproduction control, based on the reproduction path information and the stream management information.

The AV stream is a digital stream in MPEG-TS (Transport Stream) format, and is obtained by multiplexing the video stream, the audio stream and sub-video streams, such as subtitles.

A fourth layer (BD reproduction program) is a layer that realizes the dynamic scenario of the AV stream. The dynamic scenario is a scenario to dynamically change reproduction progress of the AV stream according to user operation, status of the device, or the Java application. This fourth layer defines the reproduction control based on the user operation, status, or the Java application.

Note that in this embodiment, there are two modes for the reproduction control that dynamically changes according to user operation. One of the modes is a mode that normally reproduces AV data of the AV content recorded on the BD-ROM 104 (HDMV mode). The other is a mode to enhance an added value of the video content (BD-J mode). For example, graphics are drawn overlaid on AV data of the video content recorded on the BD-ROM 104.

The fourth layer defines the reproduction control by the two modes that are the abovementioned HDMV mode and BD-J mode. In HDMV mode, a scenario program describing a scenario is executed. The scenario describes the reproduction progress of the video content is changed according to the user operation. On the other hand, BD-J mode is a mode to perform reproduction mainly using the Java virtual machine. In BD-J mode, reproduction control of a video content is performed in response to execution of the Java application.

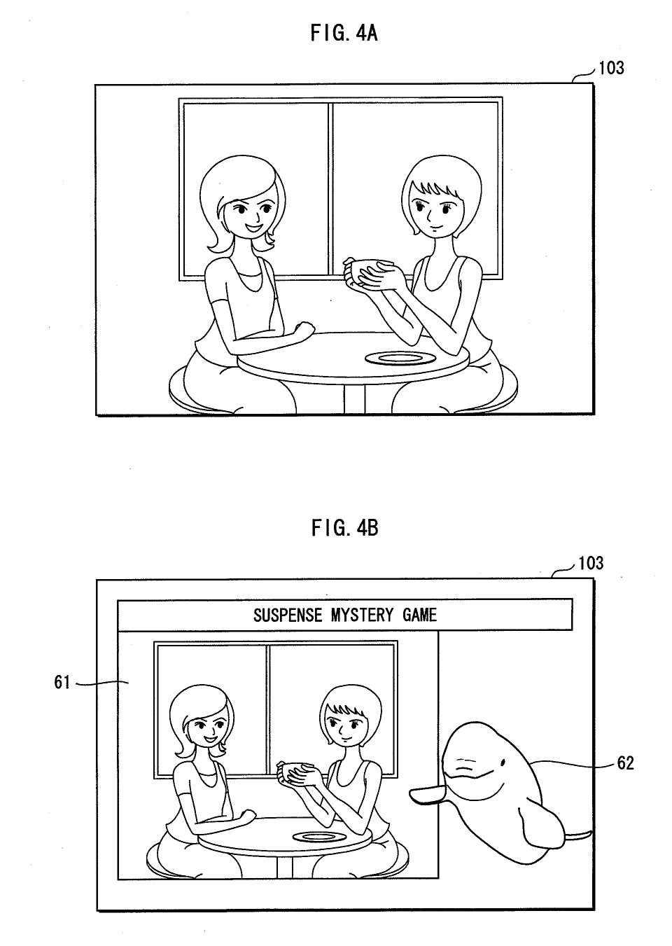

FIGS. 4A and 4B show display examples of images that are reproduced with use of the above two modes of dynamic reproduction control.

FIG. 4A shows an example of an image displayed by defining the dynamic reproduction control in HDMV mode. In HDMV mode, the reproduction control is defined so that a content is reproduced according to a menu selected by a user.

FIG. 4B shows an example of an image displayed by defining the dynamic reproduction control in BD-J mode. In BD-J mode, a control sequence can be described in the Java language that is supported by a Java virtual machine. For example, when the operation of computer graphics (CG) is controlled by this reproduction control, as shown in FIG. 4, the reproduction control is defined in such a manner that a CG image 62 that represents a dolphin is moving about by the side of a display of a moving image 61.

### <Structure>

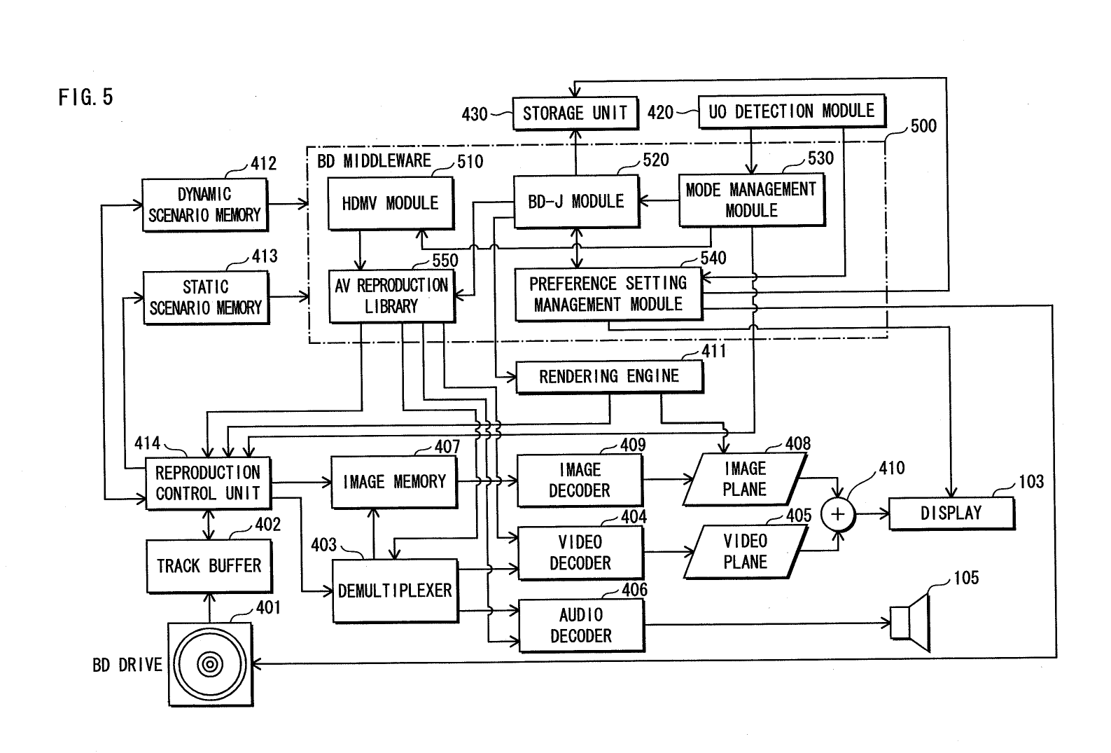

FIG. 5 is a view showing the structure of the reproducing device 101 in accordance with the embodiment of the present invention.

As shown in FIG. 5, the reproducing device 101 is constituted of a BD-ROM drive 401, a track buffer 402, a demultiplexer 403, a video decoder 404, a video plane 405, an audio decoder 406, image memory 407, an image plane 408, an image decoder 409, an adder 410, a rendering engine 411, static scenario memory 413, a reproduction controlling unit 414, dynamic scenario memory 412, a UO (User Operation) detection module 420, and BD middleware 500.

The following is a detailed description of the functions of each constituent.

The BD-ROM drive 401 performs loading and ejecting of the BD-ROM 104, and has a function to gain access to the BD-ROM 104.

The track buffer 402 is realized by FIFO memory, and has a function to store, in first-in-first-out system, ACCESS UNITS that are read from the BD-ROM 104 by the BD-ROM drive 401.

An ACCESS UNIT is a minimum decode unit that includes one GOP (Group of Pictures) and an audio frame to be read at the same time as this GOP. Note that the GOP includes: a B picture that is compressed using a time correlation characteristic of images to be reproduced in a past direction and a future direction; a P picture that is compressed using a time correlation characteristic with images to be reproduced in the past direction; and an I picture that is compressed without the time correlation characteristic but with a space frequency characteristic of images in one frame.

The demultiplexer 403 demultiplexes a transport stream that is stored in the BD-ROM 104 mounted on the BD-ROM drive 401, and has a function to extract video frames and audio frames that compose the GOP. The demultiplexer 403 outputs the extracted video frame to the video decoder 404, and the extracted audio frame to the audio decoder 406. In addition, the demultiplexer 403 stores the sub-video streams, such as subtitles, in the image memory 407, and navigation button information in the dynamic scenario memory 412.

Note that the demultiplex performed by the demultiplexer 403 includes processing to convert TS packets to PES packets.

The demultiplexer 403 demultiplexes the TS packets as follows. Based on a time stamp attached to the TS packets and a clock inside the reproducing device 101, the demultiplexer 403 fetches the PES packets from the TS packets that compose the AV stream read from the BD-ROM 104, and fetches main data that includes the video frame and the audio frame. Subsequently, the demultiplexer 403 outputs the data to the video decoder 404, the audio decoder 406 and the image memory 407.

The video decoder 404 expands pictures of the video frame outputted from the demultiplexer 403, and writes the expanded picture in the video plane 405.

The video plane 405 is memory, and stores pictures in uncompressed format.

The audio decoder 406 expands the audio frame that is outputted from the demultiplexer 403, and outputs the expanded audio data.

The image memory 407 is a buffer, and stores the sub-video stream read by the demultiplexer 403, the PNG data included in the navigation button information, or an image file that is read from the BD-ROM 104 via the reproduction controlling unit 414.

The image decoder 409 expands the sub-video stream, the PNG data, and the image files that are stored in the image memory 407, and writes the expanded data in the image plane 408. The image decoder 409 decodes the sub-video stream so that each menu and sub-videos of BD-ROM 104 to be displayed on a screen.

The image plane 408 is memory that has a memory area for one screen, and arranges the expanded sub-video stream, PNG data, image file.

The adder 410 overlays the picture data in an uncompressed format stored in the picture plane 405 with the expanded image in the image plane 408, and outputs the overlaid data. The adder 410 overlays the image in the image plane 408 and the picture in the video plane 405. Thus, a screen image shown in FIG. 4B is displayed.

The rendering engine 411 is provided with infra structure software, such as Java 2D and OPEN-GL (Open Graphics Library). The rendering engine 411 draws computer graphics, following an instruction from the BD-J module 520, and outputs the drawn computer graphics to the image plane 408.

The static scenario memory 413 is memory to store a current PL or current stream management information.

Note that the stream management information includes attribute information, such as a stream coding scheme, a frame rate, a bit rate, and a resolution of the VOB file that corresponds to each MPEG stream.

The current PL is a playlist that is currently subject to reproduction out of a plurality of playlists that are recorded on the BD-ROM 104. The current stream management information is an item of the stream management information that is currently subject to reproduction out of a plurality of items of stream management information that are recorded on the BD-ROM 104.

The dynamic scenario memory 412 is memory that stores a current dynamic scenario, and used when an HDMV module 510 and a BD-J module 520 perform the processing.

The current dynamic scenario is a scenario that is currently executed. The scenario is one of plural scenarios recorded on the BD-ROM 104.

The reproduction controlling unit 414 is constituted of CPU and memory (ROM and RAM). The CPU executes a program stored on the ROM, and consequently, a video content recorded on the BD-ROM 104 is reproduced.

More specifically, the reproduction controlling unit 414 follows a mode instructed by a mode management module 530 and a reproduction control instruction from an AV reproduction library 550, and transmits the ACCESS UNIT that is read from the track buffer 402 using the static scenario memory 412 and the dynamic scenario memory 413 to the demultiplexer, and performs reproduction based on the reproduction-control-use preference information.

The reproduction controlling unit 414 has the following function. For example, when the application executed by the BD-J module 520 involves drawing of image data in synchronization with a reproducing timing of the AV stream, information that indicates a timing of drawing the image data is received from the rendering engine 411. The reproduction controlling unit 414 performs reproduction control so that the drawing timing of the image data is synchronized with the reproducing timing of the AV stream.

The UO detection module 420 detects user operation (herein after, referred to as “UO”) that is performed on the remote controller 102 or a front panel of the reproducing device 101, and outputs the detected UO to the mode management module 416.

A storage unit 430 is realized by a hard disk or nonvolatile memory, and stores the user setting preference information and the reproduction-control-use preference information.

The BD middleware 500 is constituted of the HDMV module 510, the BD-J module 520, the mode management module 530, a preference setting management module 540, and the AV reproduction library 550. The following describes each constituent.

The HDMV module 510 is an entity executing in HDMV mode, and has a function to execute the current scenario program read by the dynamic scenario memory 412.

The BD-J module 520 is a Java platform, and is composed of a Java virtual machine, a configuration and a profile. The BD-J module 520 has a function to execute a Java application. That is to say, the BD-J module 520 generates a Java object of the current dynamic scenario from a Java class file that is read by the dynamic scenario memory 412, and executes the Java object.

Note that the Java platform includes CPU. The Java virtual machine sequentially interprets the Java object that is described in the Java language and converts the Java object to a native code that is executable by the CPU. Accordingly, the CPU executes the native code.

More specifically, the BD-J module 520 has a function to supply, to a Java application 600, API to control the reproduction of the BD-ROM 104, and preference information API to gain access to the preference information. When the Java application 600 calls the API used for media reproduction control, the BD-J module in turn calls a function that corresponds to the AV reproduction library 550 is called, and thus the AV reproduction control is performed. In addition, when the Java application 600 calls the preference information API by specifying a parameter that indicates a type of the preference information, the BD-J module judges whether a password is set for the user setting preference information. If the password is not set, the reproduction-control-use preference information that corresponds to the parameter of the API is updated.

Also, the BD-J module 520 receive sa request for accessing the preference information from the Java application, and gains access to the storage unit 430. For example, when a reading and writing request of the preference information is received from the Java application 600, the BD-J module 520 reads and writes data of the reproduction-control-use preference information that corresponds to the request stored in the storage unit 430.

Also, the BD-J module 520 manages start and termination of the Java application, based on application management information recorded on the BD-ROM 104. In addition, the BD-J module 520 receives an event of the UO transmitted from the UO detection module 420, and transmits the event to the Java application that is currently in operation.

The mode management module 530 includes a dispatcher, and holds the mode management table read from the BD-ROM 104. The mode management module 530 has a function to detect a switching of the titles during the reproduction of the BD-ROM 104 and perform mode management and branch control.

The mode management is to allocate a module that causes the dynamic scenario to be executed to either of the HDMV module 510 and the BD-J module 520. The branch control is to determine to which of the BD-J module 520 and the HDMV module 510 an instruction of starting or terminating of the title is to be issued when the title is switched to another title. The determination is made according to from which to which mode the title is switched.

The dispatcher selects the only UO that is appropriate for a current mode out of UOs detected by the UO detection module 420, and transmits information that indicates the selected UO to a module that corresponds to the current mode. For example, during HDMV mode execution, when UOs requesting an up-to-down and right-to-left activation is received, these UOs are outputted to the module in HDMV mode.

Via the UO detection module 420, the preference setting management module 540 transmits the user setting preference information and the password received from the user to the storage unit 430. When the reproducing device 101 is turned ON, or a termination instruction to terminate the application is received from the AV reproduction library 550, the preference setting management module 540 replaces reproduction-control-use preference information with the user setting preference information.

The AV reproduction library 550 executes an AV reproduction function and a playlist reproduction function in response to a function call from the HDMV module 510 and the BD-J module 520.

The AV reproduction function is processing, such as start of reproduction, stop of reproduction, pause, release of a pause, release of a still image function, fast-forward whose reproducing speed is specified by an immediate value, reverse whose reproducing speed is specified by an immediate value, sound switching, sub-video switching, and angle switching. The playlist reproduction function is a kind of the AV reproduction function that starts and stops the reproduction according to the playlist information.

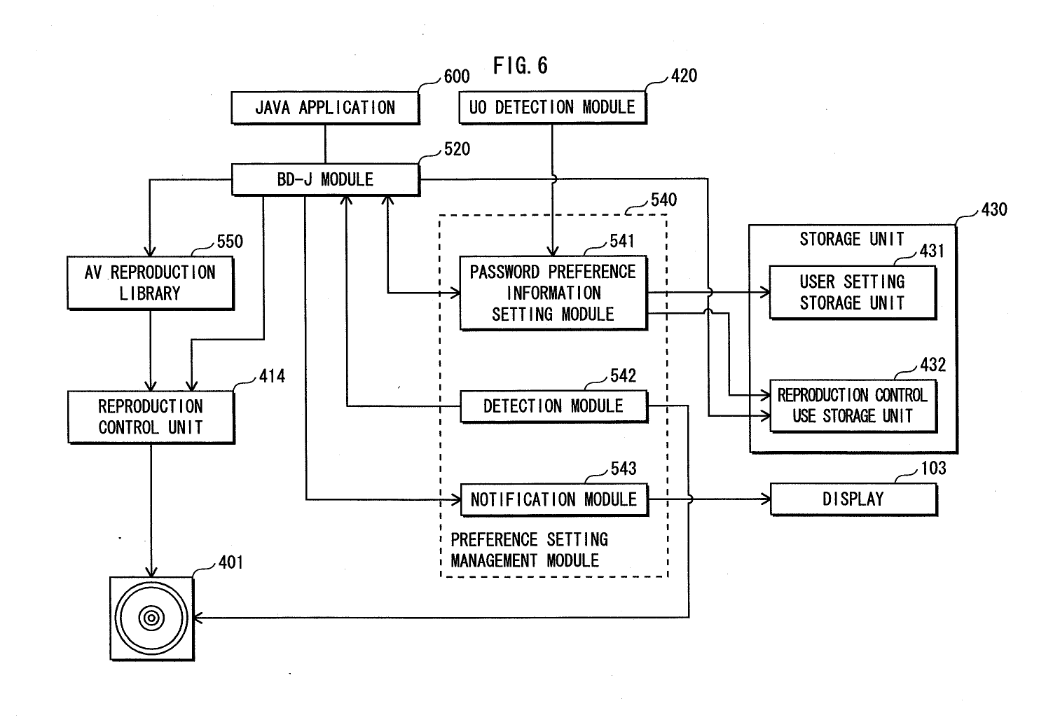

FIG. 6 is a view showing a concrete configuration of the preference setting management module 540 and the storage unit 430, and a relation between the abovementioned constituents in connection with the configuration.

The following describes each constituent.

The storage unit 430 includes a user setting storage unit 431 and a reproduction-control-use storage unit 432. The user setting storage unit 431 is a storage area that stores the user setting preference information. The reproduction-control-use storage unit 432 is a storage area that stores the reproduction-control-use preference information.

Note that during the reproduction of a video content, the BD-J module 520 gains access to the reproduction-control-use storage unit 432 alone, and that the reproduction controlling unit 414 controls the reproduction with use of the reproduction-control-use preference information stored in the reproduction-control-use storage unit 432.

The preference setting management module 540 is constituted of a password preference information setting module 541, a detection module 542 and a notification module 543.

Via the UO detection module 420, the password preference information setting module 541 receives user input of the user setting preference information and user input of the password corresponding to the user setting preference information, and transmits the setting input and the password input of the user setting storage unit 431. Note that the password is inputted by the user when the user changes the user setting preference information.

When the reproducing device 101 is turned ON by a user, the password preference information setting module 541 copies the user setting preference information in the user setting storage unit 431 to the reproduction-control-use storage unit 432, and store the user setting preference information as the reproduction-control-use preference information.

When the password preference information setting module 541 receives, via the UO detection module 420, information indicating the reproduction stop and completion of the transition to a reproduction menu screen of the BD-ROM 104, the password preference information setting module 541 copies again the user setting preference information in the user setting storage unit 431 as the reproduction-control-use preference information in the reproduction-control-use storage unit 432.

The detection module 542 detects whether the BD-ROM 104 is inserted in the BD-ROM drive 401. The detection module 542 reads application information that indicates unbound information and an ID of a disk (herein after, referred to as “disk ID”) from the BD. INFO file of the inserted BD-ROM, and stores the application information and the disk ID in memory.

When a disk of BD-ROM is inserted after the removal of the BD-ROM 104, the detection module 542 judges whether application information that is identical with the application information stored in the memory is stored in the newly inserted BD-ROM, and whether a disk ID that is identical with the disk ID stored in the memory is stored in the newly inserted BD-ROM. Subsequently, the detection module 542 transmits information indicating a judgment result to the BD-J module 520.

Note that when the application information and the disk ID do not match their counterparts, the BD-J module 520 terminates an application of the BD-ROM 104, and the password preference information setting module 541 replaces the reproduction-control-use preference information with the user setting preference information.

The notification module 543 receives, from the BD-J module 520, update result information that indicates whether the reproduction-control-use information has been updated, and generates a notification image according to the update result information. Thus, the image is displayed on the display 103.

### <Data>

The following describes data used by the reproducing device 101.

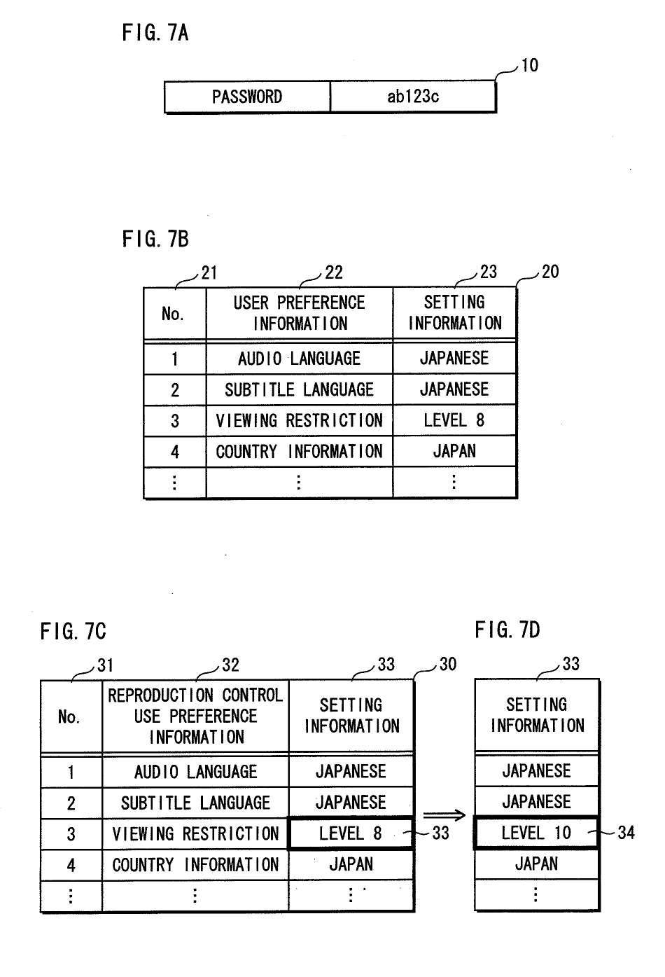

FIGS. 7A-7C each show table data stored in the storage unit 430 in accordance with the embodiment of the present invention.

The following describes each of FIGS. 7A-7C.

FIG. 7A shows password information of the user setting preference information.

Password information 10 is stored in the user setting storage unit 431 by the password preference information setting module 541 that receives an input operation of a password from a user.

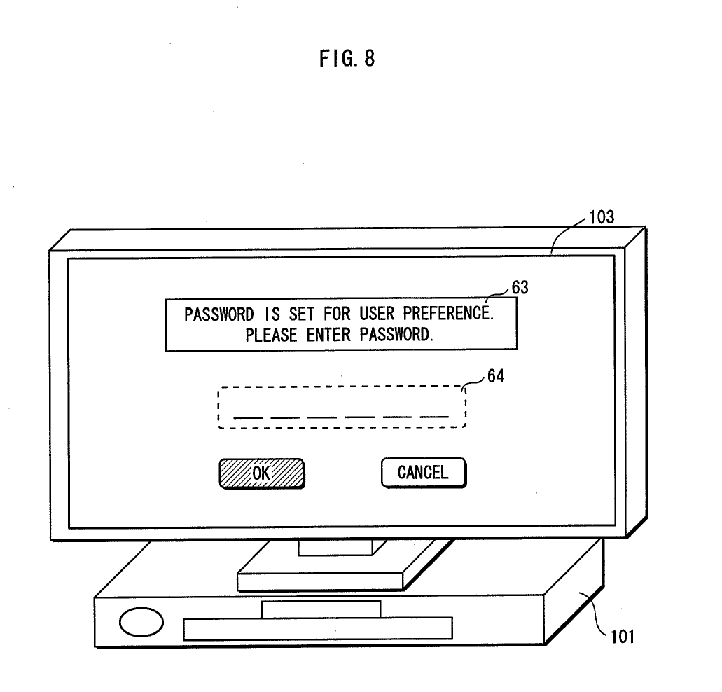

The password setting operated by a user is described with reference to FIG. 8.

FIG. 8 shows the reproducing device 101 and a display 103 in accordance with the embodiment of the present invention. The display 103 shows a password setting screen that displays images 63 and 64 for receiving the password inputted by the user. The password setting screen is displayed in response to the user operation of the remote controller 102. When the user inputs the password that corresponds to the user setting preference information, the inputted password is stored in the user setting storage unit 431.

FIG. 7B shows a structure and data of a user setting preference information table by way of example.

A user setting preference information table 20 stores number 21, user preference information 22, and setting information 23 that are associated with one another.

The number 21 is an identifier to identify the user setting preference information, and is identical with the parameter of the API that calls the preference information from the Java application 600. The user preference information 22 is reproduction control information used for reproducing a video content, such as an audio language, a subtitle language, and a viewing restriction of the video content reproduced by the reproducing device 101. The setting information 23 indicates a setting value associated with each item of the user setting preference information. Each item of the setting information 23 is stored as a factory default or as set by a user.

As shown in FIG. 7B, for example, in an “audio language” of the user preference information 22, “Japanese” is set as the setting information 23. When the BD-ROM 104 that includes English and Japanese audio data is reproduced, Japanese audio is outputted.

Note that the “level 8” in the setting information 23 of the “viewing restriction” in the user preference information 22 shows that an age limit defined by the parental lock is eight years old. For example, when the BD-ROM 104 includes the parental lock information indicating the age limit for viewing the content is eighteen years old and over, an age shown by the viewing restriction of the reproducing device 101 falls within the age limit indicated by the parental lock information. Consequently, the reproduction control is performed so as to prevent the reproducing device from reproducing the video content of the BD-ROM 104.

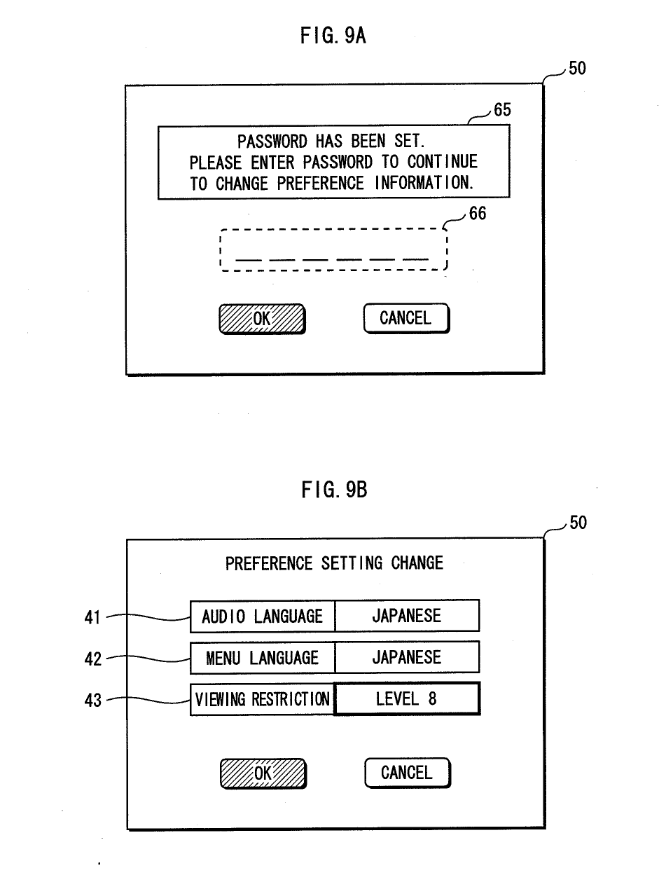

The following describes, with reference to FIGS. 9A and 9B, a case in which a user changes the user preference information of the user setting preference information table 20.

FIGS. 9A and 9B each show a display screen 50 of the display 103. In a case where the password is set in the user setting preference information table 20, as shown in FIG. 9A, a password entry screen that shows the images 65 and 66 for entering the password is displayed when the user preference information is changed.

In this embodiment, in order to change the user preference information, a user enters the password in the password entry screen shown in FIG. 9A, and consequently, a screen for changing the preference setting information, as shown in FIG. 9B, is displayed.

Note that each item of the preference information represented by input boxes 41-43 in the preference setting change screen as shown in FIG. 9B is an item of the user setting preference information stored in the user setting storage unit 431. The user can change, using the remote controller 102, the setting of the preference information displayed on the preference setting change screen.

FIG. 7C shows a structure and data of a reproduction-control-use preference information table by way of example.

Similarly to the user setting preference information table 20, a reproduction-control-use preference information table 30 stores a number (No.) 31, preference information 32, and setting information 33 being associated with one another.

The reproduction-control-use preference information table 30 has a basically identical structure with the user setting preference information table 20. However, the application execution does not enable the BD-J module 520 to gain access to the setting information 23 of the user setting preference information table 20. Rather, the execution enables the BD-J module 520 to gain access to the setting information 33 of the reproduction-control-use preference information table 30.

FIG. 7D shows the setting information 33 when the “viewing restriction” of the setting information 33 in the preference information 32, shown in FIG. 7C, is updated from “level 8” to “level 10” in response to the BD-J module 520 that executes the application during the operation of the reproducing device 101 that is to be described later.

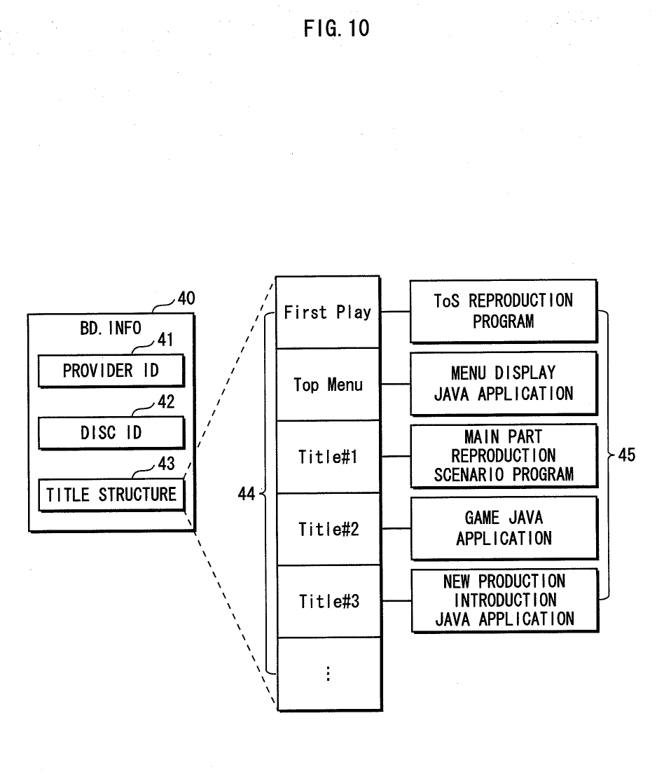

FIG. 10 is a view showing reproduction units of the BD-ROM 104 in accordance with the embodiment of the present invention. The following describes titles that indicate the abovementioned reproduction units of the BD-ROM 104.

The BD. INFO 31 of FIG. 10 indicates a BD. INFO file 40 recorded on the BD-ROM 104. The BD. INFO file stores a provider ID 41 that identifies a provider of a package of the BD-ROM 104, a disk ID 42 that indicates a title of the BD-ROM 104, and a title structure 43.

The title structure 43 includes title information 44 that indicates reproduction units each associated with the application of the BD-ROM 104 and the AV stream. The title information 44 stores execution information 45 that includes an application and a scenario program to be executed for each title. Each item of the title information 44 is associated with an application or a scenario program.

When the BD-ROM 104 is inserted, the reproduction controlling unit 414 reproduces a “First Play” that displays the terms of service of the BD-ROM 104 and such. When a menu key is pressed down in response to user operation of the remote controller 102, a “TOP MENU” is reproduced.

In this embodiment, when the user operation or the Java application 600 switches the titles, the reproduction controlling unit 414 executes applications or scenario programs associated with each title. When the title is switched to Top Menu in response to the user operation of the remote controller, or when the user stops the reproduction of the application with the remote controller 102 during the execution of the application, the BD-J module 520 terminates the application in execution, and subsequently notifies the password preference information setting module 541 of the termination of the application.

### <Operation>

The following describes the operation of the reproducing device 101 in accordance with the embodiment of the present invention.

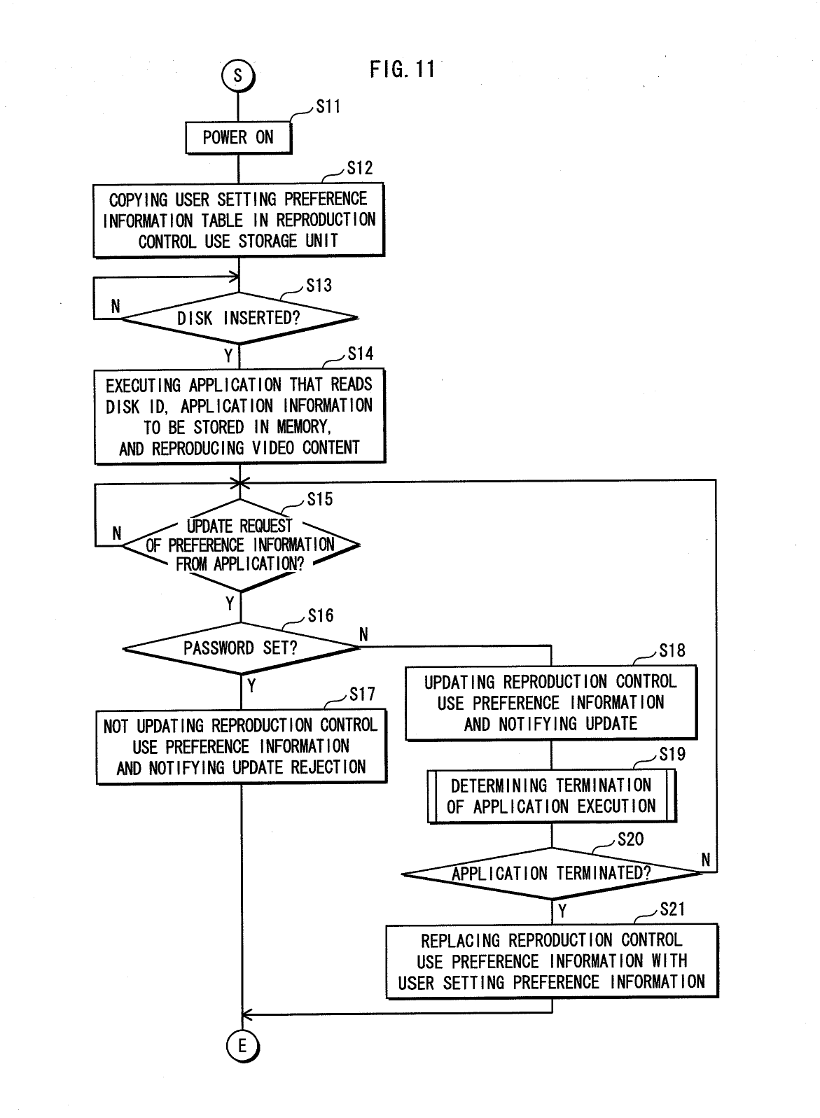

FIG. 11 shows an operational flow diagram of the reproducing device 101 in accordance with the embodiment of the present invention.

When the reproducing device 101 is tuned ON by a user in Step S11, the password preference information setting module 541 transmits a content of the user setting preference information table 20 stored in the user setting storage unit 431 to the reproduction-control-use storage unit 432, and writes the content in the reproduction-control-use storage unit 432 (Step S12).

When the detection module 542 detects that the user has inserted the BD-ROM 104 into the BD-ROM drive 401 and when the user plays back the BD-ROM 104 in BD-J mode (Step S13: Y), the detection module 543 reads the disk ID of the inserted BD-ROM 104 and the application information, and stores the disk ID and the application information in memory. The BD-J module 520 executes the Java application 600. The reproduction controlling unit 414 follows the reproduction control instruction from the AV reproduction library 550, and based on the reproduction-control-use preference information stored in the reproduction-control-use storage unit 432, reproduces the video content of the ACCESS UNIT read by the track buffer 402 (Step S14).

When the API that is prepared to update the preference information is called during the execution of the Java application 600 (Step S15: Y), the BD-J module 520 verifies, via the password preference information setting module 541, whether a password associated with the user setting preference information has been set (Step S16).

In Step S16, when it is confirmed that the password has been set (Step S16: Y), the BD-J module 520 does not update the reproduction-control-use preference information, but instead, transmits an update result information indicating the update result to the notification module 543 and information indicating the rejection of the update to the Java application. Based on the update result information received from the BD-J module 520, the notification module 543 generates an image that indicates that the update of the preference information has not been performed, and indicates the image on the display 103 (Step S17).

In Step S16, when it is confirmed that the password is not set (Step S16: Y), the BD-J module 520 gain access to the reproduction-control-use preference information table 30 stored in the reproduction-control-use storage unit 432. According to the execution of the Java application 600, the BD-J module 520 updates the setting information 32 of the preference information 31 that corresponds to the parameter of the API that is called by the Java application 600, and transmits update result information that indicates an update result to the notification module 543. Subsequently, the notification module 543 that receives the update result information from the BD-J module 520 generates an image that indicates that the update of the preference information has been performed, and displays the image on the display 103 (Step S18).

Subsequently, the BD-J module 520 and the detection module 542 performs execution termination determination processing that determines whether the application executed by the BD-J module 520 is terminated (Step S19).

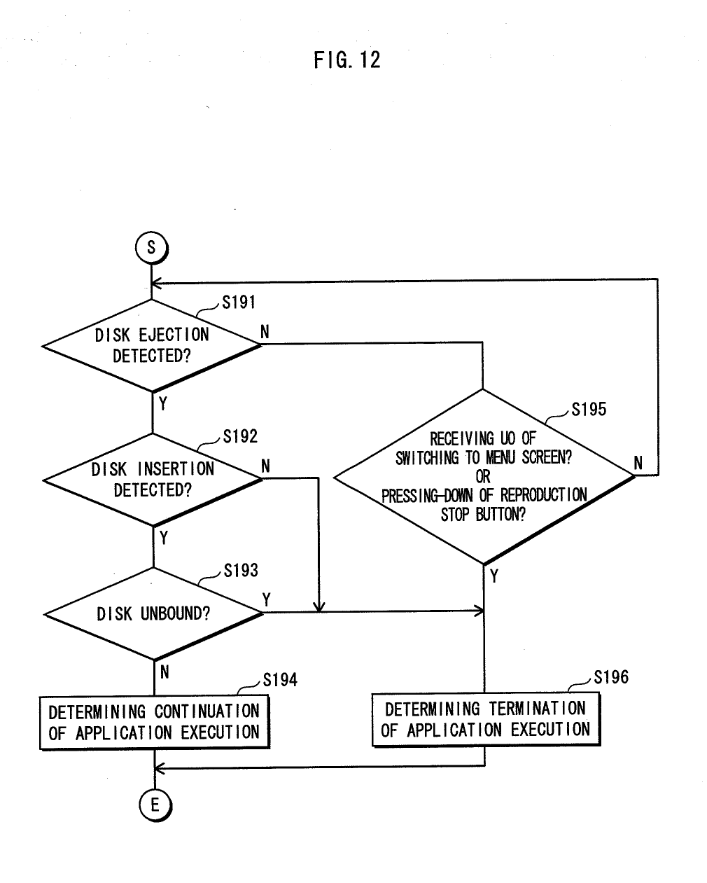

The following describes the execution termination determination processing, with reference to FIG. 12.

After the detection module 542 detects the ejection of the BD-ROM 104 in Step S191 (Step S191: Y), when the detection module 542 detects that the BD-ROM disk has been inserted in the BD-ROM drive 401 (Step S192: Y), and when application information that indicates a disk unbound application is stored in the ejected BD-ROM 104, it is determined whether the identical application information with that stored in the ejected BD-ROM 104, is stored in the inserted BD-ROM disk application information, and whether a disk ID of the inserted BD-ROM is identical with a disk ID of the ejected BD-ROM 104 (Step S193).

When the detection module 542 determines the application information and the disk ID are identical with their counterparts in Step S193 (Step S193: Y), the detection module 542 determines to continue the execution of the application that was executed before the ejection of the BD-ROM 104, and notifies this to the BD-J module 520 (Step S194).

When the detection module 542 does not detect the ejection of the BD-ROM 104 in Step S191 (Step S191: N), and when the BD-J module 520 switches to a TOP MENU screen according to user operation via the UO detection module 420 (S195: Y), the BD-J module 520 determines to terminate the application execution, and accordingly terminates the application execution. The BD-J module 520 transmits information that indicates the termination of the application execution to the password preference information setting module 541 (Step S196).

When the detection module 542 does not detect the BD-ROM disk is inserted in Step S192 (S192: N), in Step S193, when the detection module 542 determines that the application information and the disk ID that are identical with those stored in the BD-ROM 104 are not stored in the inserted BD-ROM (Step S193: N), the above processing of Step S196 is performed.

Note that when the determination results of Step S191 and Step S195 are both negative, the execution termination determination processing is repeated.

In Step S20 of FIG. 11, the password preference information module 541 receives a result of the execution termination determination processing from the BD-J module 520. When the execution termination determination processing result shows termination of the execution of the application (Step S20: Y), the password preference information setting module 541 replaces the reproduction-control-use preference information table 30 stored in the reproduction-control-use storage unit 432 with the user setting preference information table 20 stored in the user setting storage unit 431 (Step S21).

Also in Step S20, when the execution termination determination processing result received from the BD-J module 520 indicates to continue the execution of the application (Step S20: N), the BD-J module 520 continues the execution of the application, and the reproduction controlling unit 414 continues to reproduce the video content with use of the updated reproduction-control-use preference, repeating the processing of steps that follow Step S15.

The following describes an example where an image generated by the notification module 542 based on the update result information is displayed on the display 103 in the abovementioned Steps S17 and S18.

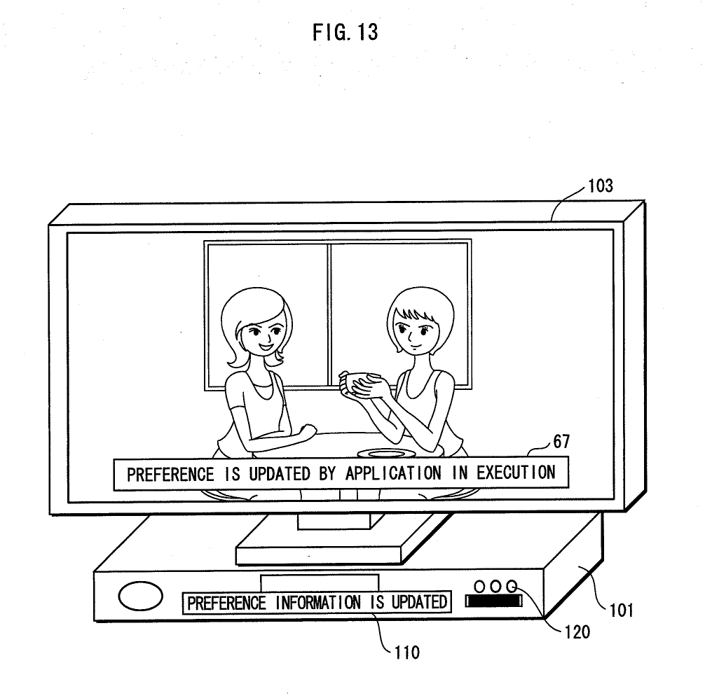

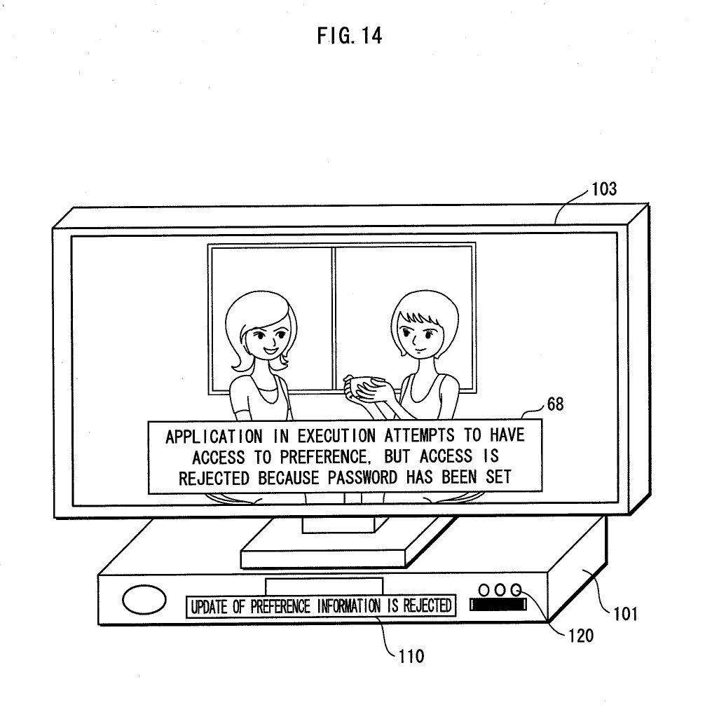

FIG. 13 shows an example of the notification image that the notification module 543 displays on the display 103 in Step S18. FIG. 14 shows an example of the notification image displayed on the display 103 in Step S17.

As shown in FIG. 13, when the preference information has been updated, the notification module 543 displays an image 67 that indicates the update of the preference information on the screen 50 of the display 103. When the preference information has not been updated, as shown in FIG. 14, an image 68 that indicates rejection of the update of the preference information is displayed.

As shown in FIGS. 13 and 14, when the reproducing device 101 is provided with the display 110, the display 110 may display the update of the preference information or the rejection of the update. When the reproducing device 101 is provided with lamps 120, such as LED, a user may be notified of the update of the preference information or the rejection of the update by lighting different colors of the lamps 120.

### <Example of Operation>

Based on an operational flow (FIG. 11), the following describes an example of the operation where the parental lock information of the preference information is updated by the execution of the application, and where a user switches to a menu screen during the application is executed.

Note that in this operational example, the description in made on the assumption that a password is not set in the user setting preference information table 20.

In addition, since the operations of Steps S11-S14 are basically identical with the abovementioned operations, the description of the operations of these steps is omitted. The description is made particularly on steps that relate to this operational example.

In FIG. 11, the reproducing device 101 performs processing shown in Steps S11-S14. In Step S15, during the execution of the Java application 600, the API that updates the parental lock information is called by specifying a parameter that indicates the parental lock information (Step S15: Y), the BD-J module 520 confirms, via the password preference information setting module 541, that a password 10 associated with the user setting preference information is not set (Step S16: N).

The BD-J module 520 gains access to the reproduction-control-use preference information table 30 stored in there production-control-use storage unit 432. The BD-J module 520 updates the setting information 32 of the parental lock information shown by the parameter called by the Java application 600 from “level 8” to “level 10” (FIG. 7D). The BD-J module 520 transmits update result information showing the update has been performed to the notification module 543. The notification module 543 that receives the modification result information from the BD-J module 520 generates the image 67 that indicates that the preference information has been updated, and displays the image 67 on the display 103 (Step S18).

Subsequently, when the BD-J module 520 receives user operation to switch to the TOP MENU via the UO detection module 420 (Step S191: N, Step S195: Y in FIG. 12), the BD-J module 520 determines to terminate the execution of the application (Step S196 in FIG. 12). The BD-J module 520 terminates the execution of the application, and transmits an execution termination determination result that indicates the execution of the application has been terminated to the password preference information setting module 541 (Step S20: Y).

The password preference information setting module 541 resets the setting information of the parental lock information updated in Step S18 from “level 10” to “level 8” by replacing the content of the user setting preference information table 20 with the reproduction-control-use preference information table 30 (Step S21).

The video content is intended for ten-year-old audience and older because the BD-J module 520 updated the parental lock information from “level 8” to “level 10.” In such a case, note that before the update, the BD-J module 520 controls the reproduction of the video content because the age limit is eight years old. However, after the update, since the age limit was changed to ten years old, the BD-J module 520 reproduces the video content until the application in execution is terminated.

After the termination of the application, in Step S21, in order to reset the parental lock information that was set by a user to “level 8,” the video content (the age limit for viewing is ten years old and older) is not reproduced.

### <Supplemental Remark>

Up to this point, the reproducing device in accordance with the embodiment and modification of the present invention is described. However, the reproducing device can be modified as follows, and the present invention is never limited to the reproducing device of the above embodiment and modification.

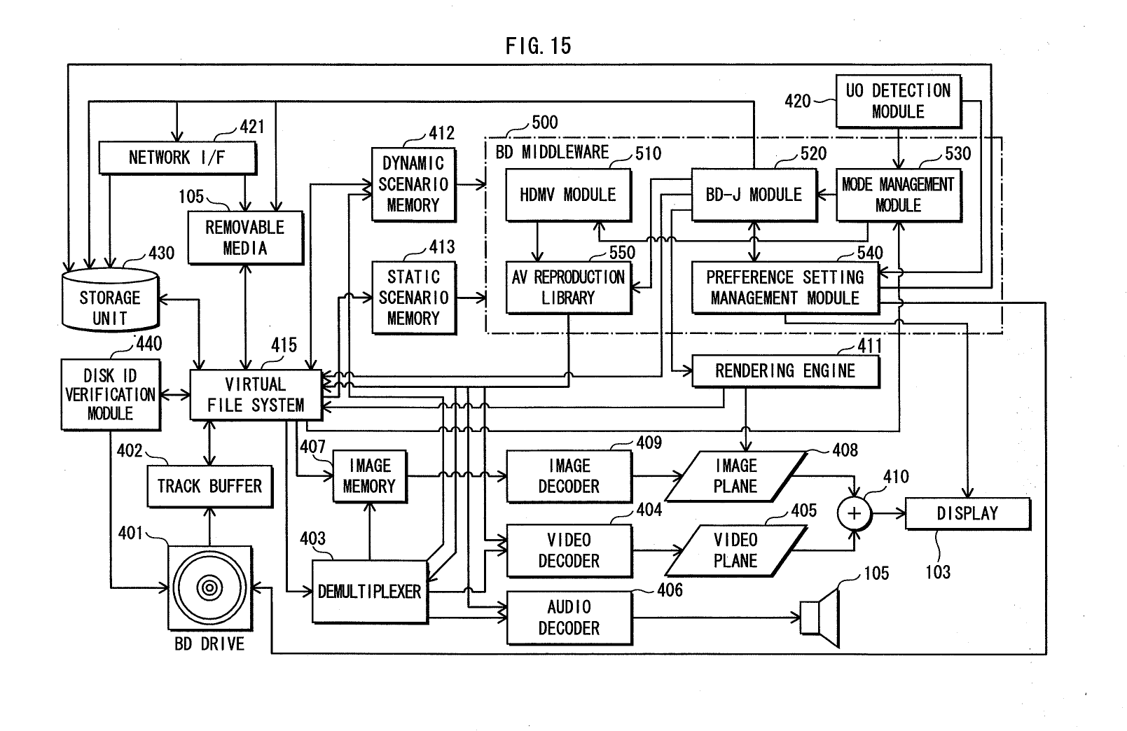

(1) The description is made on the abovementioned reproducing device 101 that reproduces a video content recorded on the BD-ROM and the Java application. However, the reproducing device 101 is also applicable to reproduction of (i) the video content and the application stored in the BD-ROM 104 (herein after, referred to as “BD package”), and (ii) the virtual package that is created by dynamically combining (a) an additional video content that relates to the video content of the BD package stored on a removable disk, such as SDRAM and a hard disk, and (b) the Java application. The reproducing device 101 with such a feature is shown in FIG. 15.

Note that removable media 105 that stores the additional video content and the application, or a storage unit 430 has a directory structure that is basically identical with that of the BD package. There is a directory whose directory name is a provider ID of the BD package. A directory whose directory name is a disk ID stores merge management information that defines an additional video content file to be merged to the BD package and a method to merge the additional video content and the like to the BD package.

Note that in the modification, description is made on the assumption that a virtual package is created by merging, into the BD package, the additional video content that is stored in the removable media 105.

In FIG. 15, based on the merge management information, a virtual file system 415 creates the directory structure of the virtual package by merging (i) the video content and the application file stored in the removable media 105 into (ii) the directory structure of the BD-ROM 104, and performs reproduction of the virtual package.

The reproduction of the virtual package is performed as follows. Based on the directory structure of the virtual package, the virtual file system 415 identifies a storage location of a file that is accessed by the Java application, reads a value of the file from the BD-ROM 104 or the removable media 105 that stores the file, and returns the value to the Java application. The Java application executes the Java program with use of the valued returned by the virtual file system 415.

In addition, in the virtual package that is created by the virtual file system 415, as shown above, when the API that updates the preference information is called by the Java application during the execution of the Java application, the BD-J module 520 performs each processing that is identical with the abovementioned embodiment (FIGS. 11 and 12).

(2) In the abovementioned embodiment, the description is made on the assumption that the preference information updated by the application execution is stored in the reproduction-control-use storage unit and that the user setting preference information is copied into the reproduction-control-use storage unit. However, the user setting preference information of the user setting storage unit is permitted to be accessed. When the power is ON, the user setting preference information may be saved by being copied to a different storage area. When the application is terminated, the saved user setting preference information may be reset.

Note that in the above case, instead of saving the user setting preference information when the reproducing device 101 is ON, the following processing may be performed. When the API that gains access to the user setting preference information is called by the Java application, the preference information that is to be accessed may be saved. When the API that gains access to the user setting preference information is initially called, the entire user setting preference information may be saved.

(3) The above embodiment is described on the assumption that when a password is set in the user setting preference information 20, the application execution does not update the preference information. However, on the condition that the preference information updated by the application execution relates to the parental lock information, if the update involves a further restriction of the age limit shown in the preference information, the BD-J module 520 may update the parental lock information in the reproduction-control-use preference information table 30.

In this case, the following occurs, for example. As shown in FIG. 7C, when the parental lock information in the reproduction-control-use preference information table 30 shows “level 8,” and the API is called to update the level to “level 5” by the application in execution, the BD-J module 520 checks whether the password is set via the password preference management information module 541. At the same time, the BD-J module 520 determines whether an age indicated by the parental lock information is smaller than the age limit shown in the current setting information. Even though a password is set, if the age resulted from the update is small, it is judged that the age limit is stricter. Thus, the setting information of the reproduction-control-use parental information is updated to “level 5.”

(4) The above embodiment is described on the assumption that if a password is not set, the preference information is updated. However, for example, each item of the preference information may be stored associated with an item of information that indicates whether to permit the update of the preference information. Based on the password or this information, the update of each item of the preference information may be determined.

In this case, even if a password is not set, the preference information that is not updated by the application execution is stored being associated with the information that does not permit the update. Thus, the preference information can be controlled not to be updated.

(5) The abovementioned embodiment is described on the assumption as follows. When reproduction termination operation of the BD-ROM 104 is received from a user, when the operation to transit to the TOP Menu screen, and when the BD-ROM 104 that is not a disk unbound is ejected from the BD-ROM drive, the application is assumed to be terminated, and the user setting preference information is stored in the reproduction-control-use storage unit. However, in addition to the above embodiment, the user setting preference information may be stored when operations that are irrelevant to the processing of the application in execution such as user operation of displaying a screen and the like that changes the setting of the user setting preference information.

(6) In the above embodiment and the modification, the Java language is used as a programming language of the virtual machine. However, instead of the Java language, other programming languages, such as B-shell, Perl Script, and ECMA Script that are used in UNIX™ OS may be used.

In addition, in the above embodiment, the reproducing device that reproduces the BD-ROM is described. However, when necessary data on the BD-ROM 104 that is used in the embodiment is recorded on a writable optical recording medium, the above effect is also achieved.

(7) Processing of each step that is described in the operation of the embodiment may be a computer program that is realized by a computer system, or digital signals that represent the program. The present invention may be a computer readable recording medium that records the program or the digital signals, such as a flexible disk, a hard disk, a CD, an MO, a DVD, BD, and semiconductor memory.

Also, the present invention may be the computer program or the digital signals that are transmitted via a network, such as an electric communication line, a wired or wireless communication line, and the Internet.

Also, the program and the digital signals may be recorded on the recording medium, and transmitted in such a manner. Alternatively, the program and the digital signal may be transmitted via the network, and implemented in other independent computer systems.

### INDUSTRIAL APPLICABILITY

The reproducing device in accordance with the present invention is applicable to a reproducing device that reproduces a video content recorded on an optical disk, such as BD-ROM.

1. A reproducing device that reads a video content and an application from a recording medium and reproduces the video content, the application executed when the video content is reproduced, the reproducing device comprising:
a first storage unit that stores first setting information set by a user for controlling reproduction of the video content;
a second storage unit that stores second setting information that is readable and writable by the application, the second setting information used for controlling reproduction of the video content;
an execution unit operable to execute the application based on the second setting information when the video content is reproduced; and
a control unit operable, at a time when the execution of the application is terminated, to control the second storage unit to replace the second setting information with the first setting information.

2. The reproducing device of claim 1, further comprising:
a reception unit operable to receive, from the user, a termination instruction to terminate the execution of the application, wherein
the control unit determines a time when the reception unit receives the termination instruction as the time when the execution of the application is terminated.

3. The reproducing device of claim 1, wherein
the recording medium includes link information indicating whether or not the application is executed for both the video content included in the recording medium and a video content included in an other recording medium,
the reproducing device further comprises:
an interface from which the recording medium is removable; and
a detection unit operable to detect (i) whether the recording medium has been removed from the interface, and (ii) whether the other recording medium includes the link information when the other recording medium is mounted on the interface after the removal of the recording medium, and
the control unit determines a time when the detection unit detects that the other recording medium does not include the link information as the time when the execution of the application is terminated.

4. The reproducing device of claim 1, wherein
the first storage unit stores a password associated with the first setting information,
the control unit further includes a determination subunit operable to determine, when the application in execution attempts to update the second setting information, whether the password is set associated with the first setting information that corresponds to the second setting information,
when the determination subunit determines that the password is set, the control unit does not allow the second setting information to be updated, and
when the determination subunit determines that the password is not set, the control unit allows the second setting information to be updated.

5. The reproducing device of claim 4, further comprising:
a notification unit operable to notify, according to a determination result by the determination subunit, the user of access information indicating whether the application has updated the second setting information.

6. The reproducing device of claim 5, further comprising:
a display unit, wherein
the notification unit notifies the user with use of the display unit that displays an image indicating the access information.

7. The reproducing device of claim 5, further comprising:
an audio output unit, wherein
the notification unit notifies the user with use of the audio output unit that outputs a sound indicating the access information.

8. The reproducing device of claim 5, wherein
the reproducing device performs wired or wireless communication with an input unit that is provided with a display unit and that receives an instruction to control reproduction of the video content from the user, and
the notification unit notifies the user with use of the display unit that displays an image indicating the access information.

9. The reproducing device of claim 5, wherein
the reproducing device performs wired or wireless communication with an input unit that is provided with a display unit and that receives an instruction to control reproduction of the video content from the user, and
the notification unit notifies the user with use of the audio output unit that outputs a sound indicating the access information.

10. The reproducing device of claim 4, wherein
the first setting information and the second setting information include parental lock information indicating a restriction placed on the user to view the video content according to an age of the user,
the execution of the application updates the second setting information,
the password is set associated with the first setting information,
on a condition that the update of the second setting information involves tightening of the restriction indicated by the second setting information, the control unit allows the second setting information to be updated.

11. A program for execution by a reproducing device that reads a video content and an application from a recording medium and reproduces the video content, the application executed when the video content is reproduced, the reproducing device including a first storage unit that stores first setting information set by a user for controlling reproduction of the video content, and a second storage unit that stores second setting information that is readable and writable by the application, the second setting information used for controlling reproduction of the video content, the program comprising program code operable to cause a computer to perform the steps of:
executing the application based on the second setting information when the video content is reproduced; and
when the execution of the application is terminated, controlling the second storage unit to replace the second setting information with the first setting information.
